(19) United States
(12) Patent Application Publication
(10) Pub. No.: US 2014/0279492 A1
(43) Pub. Date: Sep. 18, 2014

(54) REMOTE IMAGE RECOVERY

(71) Applicant: BANK OF AMERICA CORPORATION, Charlotte, NC (US)

(72) Inventors: William H. McGraw, Charlotte, NC (US); Nathan Dent, Concord, NC (US); Dion L. Bellamy, Weldon Spring, MO (US); James D. Goodwin, Kansas City, MO (US); Matthew Bryant, Bellevue, KY (US)

(73) Assignee: BANK OF AMERICA CORPORATION, Charlotte, NC (US)

(21) Appl. No.: 13/829,005

(22) Filed: Mar. 14, 2013

(51) Int. Cl. G06Q 20/10

(52) U.S. Cl. CPC G06Q 20/1085
USPC 705/43

(57) ABSTRACT

Methods, systems, and computer-readable media are provided for resilient document image production. During a document deposit transaction, such as a check deposit, a self-service device, such as an automated teller machine (ATM), may experience a fault. In some instances, an image of the document may have been scanned prior to experiencing the fault. The self-service device may retrieve one or more scanned images, for example, over a time window prior to the fault, such as 5 minutes, and allow access to the retrieved images. A processing entity may access the retrieved images, determine that one of the retrieved images is associated with the first document deposit transaction, and resolve a claim for the document deposit transaction.

### BACKGROUND

Aspects of the disclosure relate to computer hardware and software. In particular, one or more aspects of the disclosure generally relate to computer hardware and software that can be used to provide resilient document image production.

Monitoring financial transactions at automated devices has become an important part of providing banking services. Automated devices may at times experience faults or malfunctions that negatively impact customer service. For example, a fault when depositing a check may delay fund transfers and may otherwise cause problems with customer relationships. When such a fault is experienced, a customer may open a claim with the service provider and it may be beneficial to resolve such claims in an efficient manner.

When a physical document is involved in a fault or malfunction at an automated device, the document may be physically retrieved and further physically processed. This processing may be time consuming and may have significant overhead costs. Accordingly, an efficient way to resolve customer claims is needed to reduce overhead and enhance customer satisfaction.

### SUMMARY

Aspects of the disclosure provide various techniques that enable a self-service device to initiate and complete financial transactions, which may include deposits, in a secure, intuitive, and resilient manner.

Methods, systems, and computer-readable media for resilient document image production are described. A self-service device, such as an automated teller machine (ATM), may receive a document, such as a check, as part of a first document deposit transaction. An image may be scanned and stored of the document. A fault may be detected during the document deposit transaction. For example, the fault may comprise a jammed check. One or more scanned images may be retrieved by the self-service device based on a predetermined metric. The retrieved images may be associated with additional information. A processing entity may access the retrieved images and determine that one of the retrieved images is associated with the first document deposit transaction. A claim for the first document deposit transaction may be resolved.

In an embodiment, the self-service device may receive claim information about the first document deposit transaction and may initiate a claim for the first document deposit transaction. In another embodiment, a user may initiate a claim for the first document deposit transaction.

In an embodiment, the predetermined metric may be a predetermined time window over which scanned images were stored. In another embodiment, the predetermined metric may be one or more of an account number for a user, a transaction number for the first document deposit transaction, and a check number for the document.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment according to an embodiment.

FIG. 2 illustrates another example operating environment according to an embodiment.

FIG. 3 illustrates an additional example operating environment according to an embodiment.

FIG. 4 illustrates an example method for resilient document image production according to an embodiment.

FIG. 5 illustrates an example method of resilient document image production with a user according to an embodiment;

FIG. 6 illustrates an example method of automated resilient document image production according to an embodiment;

FIG. 7 illustrates an example method for processing a claim according to an embodiment;

FIG. 8 illustrates an example process of an assisted resilient document image production according to an embodiment;

FIG. 9 illustrates an example image of a scanned check according to an embodiment;

### DETAILED DESCRIPTION

In the following description of various embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115. According to aspects of en embodiment, the computing environment 100 may represent self-service device service systems, self-service device maintenance systems, and/or self-service device service centers, or any combination thereof.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other way of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks) including various other components, such as a battery, speaker, and antennas (not shown). The service computing devices 141 and 151 may be personal computing devices or servers that include many or all of the elements described above relative to the computing device 101. Service computing device 161 may be a mobile device communicating over wireless carrier channel 171, for example as may be utilized and/or carried by a service technician during a service call.

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, and/or data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The systems, devices, and/or networks of FIG. 1 may, in one or more arrangements, be used to provide functionality to one or more self-service devices, such as cash handling devices or automated teller machines (ATMs). Self-service devices are commonly used to provide access to financial transactions without requiring an individual, such as a bank teller, to complete the transaction. Self-service devices are often associated with one or more financial institutions, however, typical self-service devices are accessible to both customers of the associated financial institution and non-customers, sometimes for a charge. One example self-service device environment 200 is shown in FIG. 2. The self-service device 202 is connected, via WAN and/or LAN 204a-204d to a network 206, such as the Internet, to communicate with one or more financial institutions 208a-208c. One of financial institutions 208a-208c, such as financial institution 208a, may be associated with the self-service device 202 while the others, such as financial institutions 208b, 208c may not be associated with the self-service device 202 but may communicate with the self-service device 202 to complete transactions by customers associated with the financial institutions 208b, 208c and conducted at the self-service device 202.

In an embodiment, self-service device 202 may include an image scanner. For example, a user may perform a document deposit transaction at self-service device 202 where the user feeds one or more documents into self-service device 202, for example, a check, and an image scanner may scan an image of the document. Self-service device 202 may then send the image of the document to one or more of financial institutions 208a-208c. In an embodiment, self-service device 202 may generate additional data related to the document, such as a type of document, a time of day when the transaction related to the document took place, a location for the self-service device that performed the transaction, and other data, and send the additional data to the one or more financial institutions 208a-208c. In one example, self-service device may perform image processing on the scanned image and generate additional data. For instance, where the document comprises a check, the additional data may comprise an amount, a payee, a payer, a routing number, an account number, a check number, and other related data.

In an embodiment, self-service device 202 may include one or more devices that are used to accept a document for scanning. For example, a user may deposit a check into a slot and one or more devices may position the check for scanning. An example scanned image of a check document is illustrated in FIG. 9. The one or more devices may then physically place the check into one or more bins for processing. The one or more bins may comprise a successfully completed bin where documents may be placed when a document deposit transaction is successfully completed and a fault bin where documents may be placed when a document deposit transaction is not successfully completed.

In an embodiment, self-service device 202 may include one or more software applications, such as application(s) 119, that are used to operate self-service device 202. For example, a software application may include a monitoring system that may, for instance, detect one or more faults at self-service device 202. An additional software application may comprise a remote connection application that allows one or more devices to remotely connect to self-service device 202. Another software application may comprise a transfer software application that is used to send and receive data to and from one or more devices or entities, for example, financial institutions 208a-208c.

In an embodiment, a financial institution may have several self-service devices. For instance, FIG. 3 illustrates one example computing environment in which a plurality of self-service devices 302a-302d are in communication with each other (such as via WAN 304a-304d) via a network 306, such as the Internet. Further, the financial institution 308 with which the self-service devices 302a-302d are associated may also be connected to the network 306, such as via WAN 305 to permit communication between each self-service device and the financial institution. In some examples, the status of one or more self-service devices 302a-302d, capacity available at one or more self-service devices 302a-302d, and/or maintenance status of one or more self-service devices 302a-302d, may be communicated to or known by other self-service devices 302a-302d and/or the financial institution.

Embodiments of resilient document image production are further described. FIG. 4 illustrates an example method for resilient document image production according to an embodiment. The method of FIG. 4 may begin at step 401, where a document deposit transaction may be started. For example, a user may perform a document deposit transaction, such as a check deposit, at self-service device 202. While performing the document deposit transaction, self-service device 202 may experience a fault. For instance, the document may become jammed in self-service device 202 or any other error may occur while performing a document deposit. In an embodiment, a fault may be detected based on an error occurring during a document deposit transaction and based on self-service device 202 failing to return the document to a user. In an example, a fault may occur before an image for the document is scanned or after an image for the document is scanned. Accordingly, in some instances, an image for the document may be scanned when a fault is experienced.

The method of FIG. 4 may proceed from step 401 to step 402, where an image for the document is captured. For example, self-service device 202 may comprise one or more devices used to position a document for scanning. An image scanner may scan the document and the scanned image may be stored, for example, in database 121 at self-service device 202. A scanned image of a document may include an image of front face of the document and the back face of the document. An example scanned image of a check document is illustrated in FIG. 9.

The method of FIG. 4 may proceed from step 402 to step 403, where a status may be detected for a deposit. In an embodiment, self-service device 202 may detect that a document is jammed in the one or more devices in self-service device 202 used to position the document. Self-service device 202 may also detect that an error has occurred while performing a document deposit. In an embodiment, a status may be detected based on an error occurring during a document deposit transaction and based on self-service device 202 failing to return the document to a user.

The method of FIG. 4 may proceed from step 403 to step 404, where an alert is raised. For example, Self-service device 202 may raise one or more alerts based on one or more statuses that indicate a jammed document, an error occurring during a document deposit transaction, a failure to return a document to a user, and any other suitable alert status.

The method of FIG. 4 may proceed from step 404 to step 405 where a raised alert is captured. For instance, one or more alerts raised may be captured, for example, by monitoring software running on self-service device 202. The method of FIG. 4 may proceed from step 405 to step 406, where image data for a predetermined number of images may be retrieved. For example, based on the captured alert indicating one or more faults, image data may be retrieved. In an embodiment, database 121 may store image data for a plurality of previously scanned document images. In an example, a predetermined number of previously scanned images may be retrieved from database 121, where the predetermined number may be defined by a threshold number of images, a threshold duration of time over which images were previously captured, such as scanned images from the last ten minutes, or any other suitable predetermined number.

The method of FIG. 4 may proceed from step 406 to step 407 where the retrieved images may be compressed. For example, the retrieved images may be zipped or otherwise compressed. The method of FIG. 4 may proceed from step 407 to step 408, where the images may be made accessible to one or more devices and/or entities, such as financial institutions 208a-208c. In an embodiment, the images may be uploaded to a shared drive and/or directory that may be accessible to one or more devices and/or entities, such as financial institutions 208a-208c. In another embodiment, the images may be transmitted to one or more devices and/or entities such that they may be accessed. In an embodiment, the images may be accessible along with additional data about the transaction. For instance, the additional data may comprise a self-service device ID and a date and time for the image retrieval. In an example the one or more devices and/or entities that may access the images may perform claim processing based on the accessed images, as further described in various embodiments.

FIG. 5 illustrates an example method of resilient document image production with a user according to an embodiment. The method of FIG. 5 may begin similar to the method of FIG. 4, where a document deposit transaction may be started. For example, the method of FIG. 5 may begin with steps 401 and 402 as described above for FIG. 4. The method of FIG. 5 may then proceed to step 501, where a deposit status is detected. Step 501 of FIG. 5 may be similar to steps 403 and 404 of FIG. 4. In an embodiment, self-service device 202 may detect that a document is jammed in the one or more devices in self-service device 202 used to position the document. Self-service device 202 may also detect that an error has occurred while performing a document deposit. In an embodiment, a status may be detected based on an error occurring during a document deposit transaction and based on self-service device 202 failing to return the document to a user. An alert may be raised based on the detected status. For example, self-service device 202 may raise one or more alerts based on one or more statuses that indicate a jammed document, an error occurring during a document deposit transaction, a failure to return a document to a user, and any other suitable alert status.

In an embodiment, the method of FIG. 5 may proceed from step 501 to both step 502 and step 505. When an error occurs during document deposit, as described above, both step 502 and step 505 may be triggered. For example, at step 502, in response to one or more alerts being raised, the one or more alerts may be captured by an application running on self-service device 202. At step 505, a user of self-service device 202 may recognize an error occurred during document deposit and the user may initiate a claim. For example, the user may detect an error based on a display for self-service device 202 indicating an error. In various embodiments, step 502 and step 505 may be performed in parallel or in series.

At step 502, one or more alerts raised may be captured, for example, by monitoring software running on self-service device 202. The method of FIG. 5 may proceed from step 502 to step 503, where images and additional data may be captured. In an embodiment, step 503 may comprise steps 406 and 407 of FIG. 4. In other embodiments, step 503 may comprise any suitable method for capturing image data, for instance image data stored in database 121 of self-service device 202, and additional data. In an example, additional data may comprise a self-service device ID and a date and time for the image retrieval.

The method of FIG. 5 may proceed from step 503 to step 504, where the captured images and additional data may be made accessible to one or more devices and/or entities, such as financial institutions 208a-208c. In an embodiment, the images may be uploaded to a shared drive and/or directory that may be accessible to one or more devices and/or entities, such as financial institutions 208a-208c. In another embodiment, the images may be transmitted to one or more devices and/or entities such that they may be accessed. In an embodiment, the images may be accessible along with additional data about the additional data about the transaction. For instance, the additional data may comprise a self-service device ID and a date and time for the image retrieval.

As described above, the method of FIG. 5 may also proceed from step 501 to step 505, where a fault is recognized and a claim is initiated. For example, a user may recognize a fault occurred during a document deposit transaction and the user may initiate a claim. For example, based on a fault occurring during a document deposit, or based on a raised alert, self-service device 202 may update a display to indicate that a fault has occurred. A user may recognize a fault based on the updated display. The user may subsequently initiate a claim by one or more of calling a customer service number for a financial institution, using a mobile device with a mobile application for initiating a claim, using web application, webpage, and/or web portal for initiating a claim, via the self-service device 202, and any other suitable manner for initiating a claim.

The method of FIG. 5 may proceed from step 505 to step 506, where an initiated claim is validated. For example, a location for a faulty transaction indicated in an initiated claim, such as a self-service device ID, may be validated. In another example, a transaction log may be accessed in order to validate that an initiated claim has not been previously completed. A claim may be initiated by a user because the user was unable to see a transaction in a transaction history. Accordingly, a delay in posting a transaction to a transaction history viewable to a user may prompt a user to initiate a claim. A transaction log may be accessed to ensure that a transaction for the claim has not already been completed. If a transaction has already been completed for a claim, a user may be notified and the claim may be dismissed.

In an embodiment, the method of FIG. 5 may proceed from step 506 to step 507, where a claim is processed. For example, a processing facility may process a validated claim. The processing facility may access the captured images and additional data, as made available in step 504. For example, the processing facility may have access to a shared drive where the captured images and additional data are stored. In another example, the captured images and additional data may be transmitted to the processing facility. The claim may be processed according to various embodiments described. The method of FIG. 5 may proceed from step 507 to step 508, where a claim is resolved based on the claim processing.

FIG. 6 illustrates an example method of an automated resilient document image production according to an embodiment. The method of FIG. 6 may begin similar to the method of FIG. 4, where a document deposit transaction may be started. For example, the method of FIG. 6 may begin with steps 401 and 402 as described above for FIG. 4. The method of FIG. 6 may then proceed to step 601, where a deposit status is detected. Step 601 of FIG. 6 may be similar to steps 403 and 404 of FIG. 4. In an embodiment, self-service device 202 may detect that a document is jammed in the one or more devices in self-service device 202 used to position the document. Self-service device 202 may also detect that an error has occurred while performing a document deposit. In an embodiment, a status may be detected based on an error occurring during a document deposit transaction and based on self-service device 202 failing to return the document to a user. An alert may be raised based on the detected status. For example, Self-service device 202 may raise one or more alerts based on one or more statuses that indicate a jammed document, an error occurring during a document deposit transaction, a failure to return a document to a user, and any other suitable alert status.

In an embodiment, the method of FIG. 6 may proceed from step 601 to both step 602 and step 605. When an error occurs during document deposit, as described above, both step 602 and step 605 may be triggered. For example, at step 602, in response to one or more alerts being raised, the one or more alerts may be captured by an application running on self-service device 202. At step 605, self-service device 202 may recognize that an error occurred during document deposit and may initiate a claim. For example, Self-service device 202 may recognize an error based on one or more of the detected statuses or raised alerts as previously described. In various embodiments, step 602 and step 605 may be performed in parallel or in series.

At step 602, one or more alerts raised may be captured, for example, by monitoring software running on self-service device 202. The method of FIG. 6 may proceed from step 602 to step 603, where images and additional data may be captured. In an embodiment, the images may be captured according to step 406 of FIG. 4. In other embodiments, one or more images may be associated with the transaction, and those associated images may be captured. For example, one or more images may be associated with one or more of an account number for a user performing the transaction, a transaction number, a document number, such as a check number, and any other suitable information related to the transaction, and those associated images may be captured. The additional data may comprise a self-service device ID, a date and time for the image retrieval, and any other suitable identifying information. In an embodiment, the additional data may comprise an identification number for a transaction that experienced a fault, identification information for a user, such as an account number, a description of one or more faults, and any other suitable identifying information. In an example, an image for a document may be processed and information about the image may be included in the additional data. For instance, an image of a check may be processed and one or more of a check number, a payer, a payee, an account number, a routing number, and any other information that may be discovered from a processed image of a check may be included as additional data.

The method of FIG. 6 may proceed from step 603 to step 604, where the captured images and additional data may be made accessible to one or more devices and/or entities, such as financial institutions 208a-208c. In an embodiment, the images may be uploaded to a shared drive and/or directory that may be accessible to one or more devices and/or entities, such as financial institutions 208a-208c. In another embodiment, the images may be transmitted to one or more devices and/or entities such that they may be accessed. In an embodiment, the images may be accessible along with additional data about the transaction. For instance, the additional data may comprise a self-service device ID, a date and time for the image retrieval, an identification number for a transaction that experienced a fault, identification information for a user, such as an account number, a description of one or more faults, information about the document determined from image processing (e.g., a check number, a payer, a payee, an account number, or a routing number) and any other suitable identifying information.

As described above, the method of FIG. 6 may also proceed from step 601 to step 605, where a fault is recognized and a claim is initiated. For example, self-service device 202 may recognize a fault occurred during a document deposit transaction and may initiate a claim. Self-service device 202 may recognize a fault based on, for example, one or more of the detected statuses or raised alerts as previously described. For instance, a fault may be recognized when a document jam status is detected or a document jam alert is raised. In an embodiment, a fault may be recognized in any other suitable manner. Self-service device 202 may communicate with a claim facility in order to initiate a claim. For example, self-service device 202 may communicate with one or more of financial institutions 208a-208c, where at least a portion of one of the financial institutions comprises a claim facility.

In an embodiment, the method of FIG. 6 may proceed from step 605 to step 606, where a user is provided details about a fault and/or claim. For example, an identification number for a claim, a description for one or more faults, a status of a claim, an estimated timing for resolution of the claim, and any other suitable information may be presented to the user. In an embodiment, a captured image and/or additional data may be provided to the user. The details may be provided to the user by, for example, displaying the details on one or more of a display for self-service device 202, a mobile device with a mobile application configured to communicate with a financial institution, a web application, webpage, and/or web portal for displaying the details, and any other suitable manner for displaying the details.

In an embodiment, the method of FIG. 6 may proceed from step 606 to step 607, where one or more of the captured images, additional data, and details are sent to a universal facility. A universal facility may comprise a universal entity where one or more financial institutions route documents, such as checks, for further routing and/or processing. Self-service device 202 may communicate with one or more of financial institutions 208a-208c, where at least a portion of one of the financial institutions comprises a universal facility.

In an embodiment, a universal facility may be capable of processing documents and/or images received from self-service device 202. For example, after receiving one or more of the captured images, additional data, and details, the universal facility may process a transaction related to an initiated claim, for example, a check deposit.

The method of FIG. 6 may proceed from step 607 to step 608, where it is determined whether the universal facility processed a document. For example, a fault may have been detected during a check deposit, and one or more of the captured images, additional data, and details about the faulty check deposit may have been sent to a universal facility. Based on the received images and data, the universal facility may be able to process the check deposit. If the check deposit is processed by the universal facility, the method of FIG. 6 may progress to step 610, where a claim is resolved. A user may be notified about the processed deposit and the resolved claim. In an embodiment, the universal facility may be unable to process the check deposit. For example, the universal facility may receive one or more of the captured images, additional data, and details about the faulty check deposit, but still may be unable to process the check deposit. This may occur based on a poor quality image for the check and/or lack of identifying information. If the check deposit is not processed by the universal facility, the method of FIG. 6 may proceed to step 609, where a claim is processed.

For example, a processing facility may process an initiated claim. The processing facility may access the captured images and additional data, as made available in step 604. For example, the processing facility may have access to a shared drive where the captured images and additional data are stored. In another example, the captured images and additional data may be transmitted to the processing facility. The claim may be processed according to various embodiments described. The method of FIG. 6 may proceed from step 609 to step 610, where a claim is resolved based on the claim processing. A user may be notified about the processed and resolved claim.

FIG. 7 illustrates an example method for processing a claim according to an embodiment. The method of FIG. 7 may begin at step 701, where it is determined whether a claim is above a predetermined amount, such as $1,000, $2,000, $5,000, or any other suitable predetermined amount. If a claim is below a predetermined amount, the method of FIG. 7 may proceed from step 701 to step 709, where the claim is processed according to a small claims process. For example, a small claims process may be similar to a secondary process, as described below with reference to step 706. If the claim is above a predetermined amount, the method of FIG. 7 may proceed to step 702, where it is determined whether the account related to the claim is a debit account, such as a checking account or a savings account, or a credit account. If it is determined that the account is a credit account, the method of FIG. 7 may proceed to step 706, where a secondary process is followed. If it is determined that the account is not a credit account, the method of FIG. 7 may proceed to step 703, where a transaction is identified.

For example, a transaction, such as a check deposit, may be identified based on the initiated claim. The initiated claim may include information such as a self-service device ID, a date and time, account information for a user, and other information that may be used to identify a transaction. Once the transaction is identified, the method of FIG. 7 may proceed from step 703 to step 704, where an upload folder is searched.

In an embodiment, as described in FIGS. 4-6, entities may be given access to captured images and/or additional data, such as at steps 408, 504, and 604. In an example, captured images and additional data may be uploaded to a shared drive that is accessible to one or more entities. For instance, at step 704, a folder on a shared drive is searched based on the identified transaction and/or claim information, where captured images and additional data have been uploaded to the shared drive.

In an embodiment, the additional data may be limited, such as in embodiments described above for FIGS. 4 and 5. For example, the additional data my comprise a self-service device ID and a date and time for an image retrieval. In such an example, an upload folder may be searched based on the limited additional data. For instance, a claim and/or transaction may indicate a self-service device ID and a data and time for a fault and a folder may be search based on this information.

In an embodiment, that additional data may comprise non-limited information about a transaction, such as in embodiments described for FIG. 6. For example, the additional data may comprise an identification number for a transaction that experienced a fault, identification information for a user, such as an account number, a description of one or more faults, and any other suitable identifying information. In an example, an image for a document may be processed and information about the image may be included in the additional data. For instance, an image of a check may be processed and one or more of a check number, a payer, a payee, an account number, a routing number, and any other information that may be discovered from a processed image of a check may be included as additional data. In such an example, an upload folder may be searched based on one or more of the exemplary additional data. For instance, a claim and/or transaction may indicate an identification number for a transaction and a folder may be search based on this information. The folder may be searched based on any other claim and/or transaction information that allows for finding an image based on the described additional data.

In an embodiment, the method of FIG. 7 may proceed from step 704 to step 705, where it is determined whether an image is found. If an image is found, the method of FIG. 7 may proceed to step 707, where a claim is completed. If an image is not found, the method of FIG. 7 may proceed to step 706, where a secondary process is followed. A secondary process may include physical retrieval of a document, for instance a jammed check in a self-service device, and physical processing of the jammed check, for instance, routing the physical check to various facilities for processing. In an embodiment, the secondary process may take several weeks to perform. The method of FIG. 7 may proceed from step 706 to step 707, where a claim is resolved. A user may be notified about the processed and resolved claim. In an embodiment, the method of FIG. 7 may omit step 701 and step 702, and may begin at step 703.

FIG. 8 illustrates an example method of an assisted resilient document image production according to an embodiment. The method of FIG. 8 may begin similar to the method of FIG. 4, where a document deposit transaction may be started. At step 801, a fault alert may be monitored at self-service device 202. In an embodiment, step 801 of FIG. 8 may comprise steps 403-405 of FIG. 4. For example, self-service device 202 may detect a status such as a jammed check and my raise an alert based on the detected status. The alert may be captured by a software application on self-service device 202. The alert may further be received at a service facility that operates a service team. For example, the service facility may access the software application on self-service device 202 that captures the alert.

The method of FIG. 8 may proceed from step 801 to step 802, where a service team member arrives at location. For example, once a service facility receives an alert, such as a jammed check alert, a service team member may be dispatched to the physical location of self-service device 202. The method of FIG. 8 may proceed from step 801 to step 802, where it is determined whether the check is in good condition. For example, a service team member may remove a jammed check and determine whether the check is in good condition. Good condition may comprise a condition such that a clear image may be scanned of the check. If the check is not in good condition, the method of FIG. 8 may proceed to step 813, where a secondary processed is followed, as described above. If the check is in good condition, the method of FIG. 8 may proceed to step 804, where a supervisor menu may be launched.

For example, a supervisor menu may be launched on self-service device 202 or another self-service device. A supervisor menu may allow a user, such as a service team member, enhanced access to a self-service device. For example, a supervisor menu may allow a user to launch a scan check screen. A user, such as a service team member, may input a predetermined code in order to launch a supervisor menu. The method of FIG. 8 may proceed from step 804 to step 805, where a scan check screen is launched. For example, from a supervisor menu, a user may launch a scan check screen that enables the user to scan a check. The method of FIG. 8 may proceed from step 805 to step 806, where the check is fed into a self-service device. For example, the check may be fed into a slot in the self-service device and the self-service device may scan an image of the check, as described above. The scanned image may comprise a rescanned image.

The method of FIG. 8 may proceed from step 806 to step 807, where it is determined whether the scan is of good quality. For example, FIG. 9 illustrates a scanned image of a check. A service team member may determine whether the rescanned image is of a quality such that it may be processed. For example, if a rescanned image is not legible, the rescanned image may not be of a quality such that is may be processed. If the rescanned image is not determined to be of good quality, the method of FIG. 8 may proceed to step 813, where secondary processes are followed, as described above. If the rescanned image is determined to be of good quality, the method of FIG. 8 may proceed from step 807 to step 808, where the rescanned check is saved to an upload folder. In an embodiment, the images are stored to an upload folder so that they may be later uploaded to a shared drive and/or folder that may be accessible to one or more devices and/or entities, such as financial institutions 208a-208c.

The method of FIG. 8 may proceed from step 808 to step 809, where generic transaction information is created for the images. For example, a scanned check may include specific transaction information as it is routed for processing. In an embodiment, generic transaction information may be created for a rescanned check. The method of FIG. 8 may proceed from step 809 to step 810, where the generic transaction information and images are uploaded. In an embodiment, the images may be uploaded to a shared drive and/or folder that may be accessible to one or more devices and/or entities, such as financial institutions 208a-208c. The method of FIG. 8 may proceed from step 810 to step 811, where generic transaction information and the image is recognized as a rescan. For example, a processing facility that accesses the information and images may recognize that the generic transaction information indicates that the images are a rescan. The method of FIG. 8 may proceed from step 811 to step 812, where the image is processed as a rescan.

In an embodiment, a service team member may have a mobile imaging device, such as a smart phone. Accordingly, instead of launching a supervisor menu, as described in step 804 in FIG. 8, the service team member may use a mobile imaging device to capture images of the check. The mobile device may then be configured to create generic transaction information and upload the generic transaction information and images to a shared drive, as further described above. The images may be then be processed according to steps 811 and 812, as described above.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computer implemented method, comprising:
receiving, at a self-service device, a document as a part of a first document deposit transaction;
scanning, at the self-service device, an image of the document;
storing, by the self-service device, the scanned image;
detecting, by the self-service device, a fault during the document deposit transaction;
retrieving, by the self-service device, one or more stored images based on a predetermined metric, wherein the images are associated with additional information comprising at least a self-service identification number for the self-service device;
accessing, by a processing entity, the one or more stored images and additional information;
determining, by the processing entity, that at least one of the one or more stored images is associated with the first document deposit transaction based on the additional information associated with the stored images; and
resolving a claim for the first document deposit transaction based on the at least one stored image determined to be associated with the first document deposit transaction.

2. A method according to claim 1, wherein the detected error comprises a jammed check.

3. A method according to claim 1, wherein the detected fault occurs prior to completion of the first document deposit transaction.

4. A method according to claim 1, wherein retrieving one or more stored images based on a predetermined metric further comprises retrieving a plurality of stored images that were scanned within a predetermined time window.

5. A method according to claim 1, wherein the additional information further comprises a time and date for the image retrieval.

6. A method according to claim 1, wherein the additional information further comprises one or more of an account number for a user and a transaction number for the first document deposit transaction.

7. A method according to claim 1, further comprising:
receiving claim information for the first document deposit transaction; and
initiating a claim for the first document deposit transaction.

8. A method according to claim 7, wherein determining that at least one of the one or more stored images is associated with the first document deposit transaction further comprises comparing claim information for the first document deposit transaction with the additional information associated with the images.

9. A method according to claim 7, wherein the claim is initiated by a user of the self-service device.

10. A method according to claim 7, wherein the claim is initiated by the self-service device.

11. A system comprising:
a self-service device, with a processor, configured to:
receive a document as a part of a first document deposit transaction;
scan an image of the document;
store the scanned image;
detect a fault during the document deposit transaction;
retrieve a plurality of stored images based on a predetermined metric, wherein the images are associated with additional information comprising at least a self-service identification number for the self-service device; and
a processing entity configured to:
access, by the processing entity, the plurality of stored images and additional information;
determine, by the processing entity, that one of the plurality of stored images is associated with the first document deposit based on the additional information associated with the stored images; and
resolve a claim for the first document deposit based on the at least one stored image determined to be associated with the first document deposit transaction.

12. A system according to claim 11, wherein the detected error comprises a jammed check.

13. A system according to claim 11, wherein the detected fault occurs prior to completion of the first document deposit transaction.

14. A system according to claim 11, wherein retrieving one or more stored images based on a predetermined metric further comprises retrieving a plurality of stored images that were scanned within a predetermined time window.

15. A system according to claim 11, wherein the additional information further comprises a time and date for the image retrieval.

16. A system according to claim 11, wherein the additional information further comprises one or more of an account number for a user and a transaction number for the first document deposit transaction.

17. A system according to claim 1, wherein the self-service device is further configured to:
retrieve claim information for the first document deposit transaction; and
initiate a claim for the first document deposit transaction.

18. A system according to claim 17, wherein determining that at least one of the one or more stored images is associated with the first document deposit transaction further comprises comparing claim information for the first document deposit transaction with the additional information associated with the images.

19. A system according to claim 1, wherein an interface device operated by a user is configure to:
receive claim information for the first document deposit transaction from the user; and
initiate a claim for the first document deposit transaction.

20. One or more non-transitory computer readable media having stored thereon instructions that, when executed by an apparatus, configure the apparatus to:
receive, at a self-service device, a document as a part of a first document deposit transaction;
scan, at the self-service device, an image of the document;
store, by the self-service device, the scanned image;
detect, by the self-service device, a fault during the document deposit transaction;
retrieve, by the self-service device, a plurality of stored images based on a predetermined metric, wherein the images are associated with additional information comprising at least a self-service identification number for the self-service device;
access, by a processing entity, the plurality of stored images and additional information;
determine, by the processing entity, that one of the plurality of stored images is associated with the first document deposit based on the additional information associated with the stored images; and
resolve a claim for the first document deposit based on the at least one stored image determined to be associated with the first document deposit transaction.
